(19) United States
(12) Patent Application Publication
(10) Pub. No.: US 2017/0076034 A1
(43) Pub. Date: Mar. 16, 2017

(54) Algorithm for constructing hypothetical evolutionary trees using common mutations similarity matrices

(71) Applicant: Peter Revesz, Lincoln, NE (US)

(72) Inventor: Peter Revesz, Lincoln, NE (US)

(21) Appl. No.: 14/852,483

(22) Filed: Sep. 11, 2015

(51) Int. Cl. G06F 19/14; G06F 19/22

(52) U.S. Cl. CPC G06F 19/14; G06F 19/22

(57) ABSTRACT

The present invention permits constructing hypothetical evolutionary trees for a set of genetically related DNA strings or a set of proteins within a protein family. The main novelty of the invention compared to other hypothetical evolutionary tree construction methods is the use of a common mutations similarity matrix.

### PRIOR PUBLICATION DATA

Revesz, P. Z. (2013) An algorithm for constructing hypothetical evolutionary trees using common mutations similarity matrices, Proceedings of the 4^{th} ACM International Conference on Bioinformatics and Computational Biology, ACM Press, pp. 731-734, Bethesda, Md., USA, September 22-25.
Revesz, P. Z. (2013) An efficient algorithm for constructing evolutionary trees using common mutation matrixes, Proceedings of the 14th International Conference on Mathematics and Computers in Biology and Chemistry, WSEAS Press, pp. 107-113, Baltimore, Md., USA, September 17-19.

### U.S. PATENT DOCUMENTS

Muto. Isamu et al. (2005) Dendogram displaying method, U.S. Pat. No. 6,847,381.
Sayood, K. et al. (2014) System and method for sequence distance measure for phylogenetic tree construction, U.S. Pat. No. 8,725,419.

### OTHER REFERENCES

### Please See at the End

### PARENT CASE TEXT

### Cross Reference to Related Applications

U.S. Provisional Patent Application 62/049,332 filed Sep. 11, 2014. No other applications.

### DESCRIPTION

### Background of the Invention

Understanding the evolutionary relationship of a set of biological organisms is an important part of many biological applications. Therefore constructing hypothetical evolutionary trees, also called phylogenetic trees, is a well-established topic with several prior algorithms proposed by other researchers (Baum and Smith [1], Hall [2], Lerney et al. [3]). Two of these algorithms, namely the neighbor joining (Saitou and Nei [7]) and the UPGMA (Sokal and Michener [9]) methods, are based on using a distance matrix for a set of nucleotide or amino acid sequences.

### SUMMARY OF THE INVENTION

The main novelty and distinguishing feature of the proposed patent is that it uses common mutations similarity matrices instead of distance matrices. The motivation behind looking for common mutations is that in practice rare but shared features, such as rare mutations, often provide useful markers of similarity among a set of closely related items.

### DETAILED DESCRIPTION OF THE INVENTION

Our hypothetical evolutionary tree construction algorithm based on common mutations similarity matrices (CMSMs) is summarized by the following pseudocode:

ALGORITHM CMSM(S₁ . . . Sₙ, n)

Input Data: S₁ ... Sₙ are n aligned nucleotide sequences, each with the
same length l. The alignment may contain gaps. (If the original sequences
are not aligned, then preprocess the data by any well-known sequence
alignment algorithm [10].)

| | |
|---|---|
| 1 | Form n clusters of sequences, each with a single sequence. |
| 2 | Find the putative common ancestor μ of the sequences. |
| 3 | Construct a graph T with a node for each n cluster and for μ. |
| 4 | Find the common mutations similarity matrix |
| 5 | While (there is more than one cluster) |

| | |
|---|---|
| 6 | If (exist distinct Sᵢ and Sⱼ with non-0 common mutations) |

| | |
|---|---|
| 7 | Merge a closest distinct Sᵢ and Sⱼ pair into a new cluster |

Sᵢⱼ and create a node for Sᵢⱼ.and update the common
mutations similarity matrix.

| | |
|---|---|
| 8 | Connect the nodes for Sᵢ and Sⱼ with parent node Sᵢⱼ. |

| | |
|---|---|
| 9 | Else |

| | |
|---|---|
| 10 | Connect the remaining clusters' nodes to parent μ. |
| 11 | Return T. |

| | |
|---|---|
| 12 | Return T. |

Next we illustrate the above algorithm using as the input data the following seven nucleotide sequences S₁ . . . S₇, each with a length fifteen nucleotides displayed by groups of five nucleotides per column in table below:

| | | | |
|---|---|---|---|
| S₁ | AGCTA | CTAGT | AATCA |
| S₂ | AGCTA | CGAGT | AATCA |
| S₃ | ATCCA | CTAGT | ACACT |
| S₄ | ATCCA | CTAGT | ATACT |
| S₅ | CGGTA | TTTGT | AAGCT |
| S₆ | CGGTT | CATCA | AATGC |
| S₇ | AGGTA | CTTGA | AATCC |

Let Sᵢ[k] denote the k^{th} nucleotide of the i^{th} nucleotide sequence, Sᵢ.

Line 2: Find a Putative Common Ancestor μ of the Sequences:

In the case of nucleotide sequences, as in the current example, we find the hypothetical common ancestor sequence, denoted μ, as the mode of each column. If there is no most frequent nucleotide in a column, then we arbitrarily chose one of the most frequent nucleotides in it.

| | | | |
|---|---|---|---|
| S₁ | AGCTA | CTAGT | AATCA |
| S₂ | AGCTA | CGAGT | AATCA |
| S₃ | ATCCA | CTAGT | ACACT |
| S₄ | ATCCA | CTAGT | ATACT |
| S₅ | CGGTA | TTTGT | AAGCT |
| S₆ | CGGTT | CATCA | AATGC |
| S₇ | AGGTA | CTTGA | AATCC |
| μ | AGCTA | CTAGT | AATCT |

### Line 4:

It can be assumed that in each sequence Sᵢ those nucleotides that do not match the corresponding nucleotide in μ were mutated at some point during evolution. In the above table those nucleotides are underscored. The common mutations similarity matrix is constructed by finding for each pair of sequences the number of underscored items, i.e., mutations with respect μ that they share. In our example, the result is the following:

| | S₁ | S₂ | S₃ | S₄ | S₅ | S₆ | S₇ |
|---|---|---|---|---|---|---|---|
| S₁ | 1 | 1 | 0 | 0 | 0 | 0 | 0 |
| S₂ | 1 | 2 | 0 | 0 | 0 | 0 | 0 |
| S₃ | 0 | 0 | 4 | 3 | 0 | 0 | 0 |
| S₄ | 0 | 0 | 3 | 4 | 0 | 0 | 0 |
| S₅ | 0 | 0 | 0 | 0 | 5 | 3 | 2 |
| S₆ | 0 | 0 | 0 | 0 | 3 | 9 | 4 |
| S₇ | 0 | 0 | 0 | 0 | 2 | 4 | 4 |

Line 7: Merging Nodes and Updating the Common Mutations Similarity Matrix:

When we merge two sequences Sᵢ and Sⱼ, in the merged sequence the k^{th} element will be equal to the nucleotide in the two sequences if Sᵢ[k]=Sⱼ[k] and will be equal to μ[k] otherwise. For example, according to the common mutations similarity matrix shown above, the closest pair of sequences is S₆ and S₇. When we merge these sequences, the matrix of sequences will be updated as follows:

| | | | |
|---|---|---|---|
| S₁ | AGCTA | CTAGT | AATCA |
| S₂ | AGCTA | CGAGT | AATCA |
| S₃ | ATCCA | CTAGT | ACACT |
| S₄ | ATCCA | CTAGT | ATACT |
| S₅ | CGGTA | TTTGT | AAGCT |
| S₆₇ | AGGTA | CTTGA | AATCC |
| μ | AGCTA | CTAGT | AATCT |

The WHILE loop is repeated until there are no more unmerged sequences or there are no similar sequences (that is, their common mutations value is simply zero). Therefore, after merging S6 and S7 into a cluster, in the next iteration of the while loop, the algorithm updates the common mutations matrix as follows:

| | S₁ | S₂ | S₃ | S₄ | S₅ | S₆₇ |
|---|---|---|---|---|---|---|
| S₁ | 1 | 1 | 0 | 0 | 0 | 0 |
| S₂ | 1 | 2 | 0 | 0 | 0 | 0 |
| S₃ | 0 | 0 | 4 | 3 | 0 | 0 |
| S₄ | 0 | 0 | 3 | 4 | 0 | 0 |
| S₅ | 0 | 0 | 0 | 0 | 5 | 2 |
| S₆₇ | 0 | 0 | 0 | 0 | 2 | 4 |

Next merging the closest pair, S₃ and S₄, yields:

| | | | |
|---|---|---|---|
| S₁ | AGCTA | CTAGT | AATCA |
| S₂ | AGCTA | CGAGT | AATCA |
| S₃₄ | ATCCA | CTAGT | AAACT |
| S₅ | CGGTA | TTTGT | AAGCT |
| S₆₇ | AGGTA | CTTGA | AATCC |
| μ | AGCTA | CTAGT | AATCT |

The updated common mutations matrix will be:

| | S₁ | S₂ | S₃₄ | S₅ | S₆₇ |
|---|---|---|---|---|---|
| S₁ | 1 | 1 | 0 | 0 | 0 |
| S₂ | 1 | 2 | 0 | 0 | 0 |
| S₃₄ | 0 | 0 | 3 | 0 | 0 |
| S₅ | 0 | 0 | 0 | 5 | 2 |
| S₆₇ | 0 | 0 | 0 | 2 | 4 |

Next merging the closest pair, S₅ and S₆₇, yields:

| | | | |
|---|---|---|---|
| S₁ | AGCTA | CTAGT | AATCA |
| S₂ | AGCTA | CGAGT | AATCA |
| S₃₄ | ATCCA | CTAGT | AAACT |
| S₅₆₇ | AGGTA | CTTGT | AATCT |
| μ | AGCTA | CTAGT | AATCT |

The updated common mutations matrix will be:

| | S₁ | S₂ | S₃₄ | S₅₆₇ |
|---|---|---|---|---|
| S₁ | 1 | 1 | 0 | 0 |
| S₂ | 1 | 2 | 0 | 0 |
| S₃₄ | 0 | 0 | 3 | 0 |
| S₅₆₇ | 0 | 0 | 0 | 2 |

Next merging the closest pair, S₁ and S₂, yields:

| | | | |
|---|---|---|---|
| S₁₂ | AGCTA | CTAGT | AATCA |
| S₃₄ | ATCCA | CTAGT | AAACT |
| S₅₆₇ | AGGTA | CTTGT | AATCT |
| μ | AGCTA | CTAGT | AATCT |

The updated common mutations matrix will be:

| | S₁₂ | S₃₄ | S₅₆₇ |
|---|---|---|---|
| S₁₂ | 1 | 0 | 0 |
| S₃₄ | 0 | 3 | 0 |
| S₅₆₇ | 0 | 0 | 2 |

Finally, the remaining clusters S₁₂, S₃₄, and S₅₆₇ can be interpreted as being separate branches that are all descendent from the common ancestor sequence μ. Hence in the else clause, the new algorithm connects the remaining clusters' nodes to μ and generates the following hypothetical evolutionary tree:

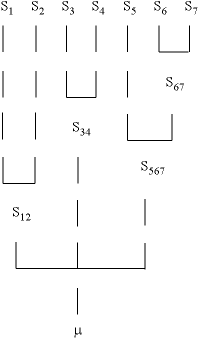

The above hypothetical evolutionary tree is different from the one that is generated by the UPGMA algorithm. Our publications [5] and [6] show the UPGMA result but is omitted from this patent application. U.S. Pat. No. 8,725,419 [8] is focused on a completely different similarity measure between genome sequences. U.S. Pat. No. 6,847,381 [4] is only tangentially related because it describes a method to visualize the phylogenetic tree instead of a method to generate the phylogenetic tree.

The CMSM algorithm can be easily adapted to a set of amino acid sequences. For amino acid sequences the μ is found by taking out of the twenty possible amino acids the one that is overall closest to the amino acids in the aligned column of amino acids. The overall closest is simply the amino acids for which the sum of similarity values to the amino acids is maximal.

### REFERENCES

[1] Baum, D. and Smith, S. (2012) Tree Thinking: An Introduction to Phylogenetic Biology, Roberts and Company Publishers.
[2] Hall, B. G. (2011) Phylogenetic Trees Made Easy: A How to Manual, 4^{th} edition, Sinauer Associates.
[3] Lerney, P., Salemi, M. and Vandamme, A.-M, editors, (2009) The Phylogenetic Handbook: A Practical Approach to Phylogenetic Analysis and Hypothesis Testing, 2^{nd} edition, Cambridge University Press.
[4] Muto. Isamu et al. (2005) Dendogram displaying method, U.S. Pat. No. 6,847,381.
[5] Revesz, P. Z., An algorithm for constructing hypothetical evolutionary trees using common mutations similarity matrices, Proceedings of the 4^{th} ACM International Conference on Bioinformatics and Computational Biology, ACM Press, pp. 731-734, Bethesda, Md., USA, Sep. 22-25, 2013.
[6] Revesz, P. Z., An efficient algorithm for constructing evolutionary trees using common mutation matrixes, Proceedings of the 14th International Conference on Mathematics and Computers in Biology and Chemistry, WSEAS Press, pp. 107-113, Baltimore, Md., USA, Sep. 17-19, 2013.
[7] Saitou, N. and Nei, M. 1987. The neighbor-joining method: A new method for reconstructing phylogenetic trees. Molecular Biological Evolution, 4, 406-425.
[8] Sayood, K. et al. (2014) System and method for sequence distance measure for phylogenetic tree construction, U.S. Pat. No. 8,725,419.
[9] Sokal, R. R. and Michener, C. D. (1958) A statistical method for evaluating systematic relationships. University of Kansas Science Bulletin, 38, 1409-1438.
[10] Jones, N. C. and Pevzner, P. A. (2004) An Introduction to Bioinformatics Algorithms, MIT Press

We claim:

1. A computer implemented method comprising: receiving as input either a set of nucleic acid sequences or a set of protein sequences; generating an initial common mutations similarity matrix; in each successive steps merging the pair of sequences that are most similar according to the current common mutations similarity matrix and then updating the common mutations similarity matrix; repeating the merging steps until there is only sequence left; finally, from the sequence of merging steps reconstruct a hypothetical evolutionary tree.

2. The method in claim 1, wherein in case of nucleotide sequences the common mutations similarity matrix is computed by first identifying a hypothetical common ancestor sequence. In the case of nucleotide sequences the computation of the hypothetical common ancestor sequence comprises of the following two steps: first an alignment of the input nucleotide sequences and second in each column of the alignment finding the most frequent nucleotide. If there is more than one with the same maximum frequency than any one of those is selected by some random method.

3. The method in claim 1, wherein in case of amino acid sequences the common mutations similarity matrix is computed by first identifying a hypothetical common ancestor sequence. In the case of amino acid sequences the computation of the hypothetical common ancestor sequence comprises of the following two steps: first an alignment of the input nucleotide sequences and second in each column of the alignment finding the amino acid that is overall closest to all the amino acids in that column. Further, the overall closest amino acid is the amino acid that has the maximum sum of similarities between it and the amino acids in the column. If there is more than one with the same maximum value than any one of those is selected by some random method.
